(19) United States
(12) Patent Application Publication
(10) Pub. No.: US 2008/0285209 A1
(43) Pub. Date: Nov. 20, 2008

(54) SOLID ELECTROLYTIC CAPACITOR

(75) Inventor: Kazutoyo HORIO, Saga-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignees: SANYO ELECTRIC CO., LTD., Osaka (JP); SAGA SANYO INDUSTRIES CO., LTD., Saga (JP)

(21) Appl. No.: 12/118,096

(22) Filed: May 9, 2008

(30) Foreign Application Priority Data
May 14, 2007 (JP) 2007-127611

(51) Int. Cl. H01G 9/15

(52) U.S. Cl. 361/523

(57) ABSTRACT

The present invention provides a solid electrolytic capacitor including an anode lead frame and/or a cathode lead frame which are/is bent to be located along a side surface and a bottom surface of a resin package, wherein each of the anode lead frame and the cathode lead frame has a projecting portion extending outward from a portion located along the bottom surface of the resin package. By providing such a projecting portion, it is possible to easily check formation of a solder fillet in mounting the solid electrolytic capacitor.

### BACKGROUND OF THE INVENTION

1. Field of the Invention

The present invention relates to a solid electrolytic capacitor including an anode lead frame and a cathode lead frame for electrically connecting a capacitor element to a mounting substrate.

2. Description of the Background Art

Solid electrolytic capacitors using, as solid electrolytes, a TCNQ (7,7,8,8-tetracyanoquinodimethane) complex salt and conductive polymers such as, polypyrrole, polythiophene, and polyflan are receiving attention. In recent years, with the increase in demand for miniaturized electronic devices, these solid electrolytic capacitors have also been required to be miniaturized and to have a larger capacitance.

FIG. 6A is a schematic plan view of one example of a conventional solid electrolytic capacitor, FIG. 6B is a schematic sectional view taken along the X-X′ line in FIG. 6A, and FIG. 6C is a schematic side view of the solid electrolytic capacitor shown in FIG. 6A. As shown in FIGS. 6A to 6C, such a conventional solid electrolytic capacitor is produced by connecting an anode lead frame 604 and a cathode lead frame 605 to an anode portion 601 and a cathode portion 602 of a capacitor element 603 (a plurality of capacitor elements 603 may be stuck on top of one another), respectively, and covering capacitor element 603 with a resin package 606, and bending anode lead frame 604 and cathode lead frame 605 protruded out of resin package 606 so that they are located along the side surface and the bottom surface of resin package 606. In each of anode and cathode lead frames 604 and 605, a portion located along the bottom surface of resin package 606 serves as a contact surface with a mounting substrate.

However, due to advances in miniaturization, terminal portions (portions to be brought into contact with a mounting substrate) of anode and cathode lead frames visible from each side of the solid electrolytic capacitor are very small, and therefore it is difficult to check formation of solder fillets during mounting the solid electrolytic capacitor.

For example, in order to make it possible to easily check formation of solder fillets from above a solid electrolytic capacitor, Japanese Patent Laying-Open No. 2006-032880 proposes a method for producing a bottom electrode-type solid electrolytic capacitor having anode and cathode terminals protruded out of a resin package.

However, such a method disclosed in Japanese Patent Laying-Open No. 2006-032880 can be applied only to solid electrolytic capacitors having a structure in which electrodes are provided only at the bottom thereof, and therefore cannot be applied to solid electrolytic capacitors having terminals formed by bending anode and cathode lead frames along a resin package, such as one shown in FIGS. 6A to 6C.

### SUMMARY OF THE INVENTION

The present invention has been made to solve the above problem, and it is an object of the present invention to provide a solid electrolytic capacitor which has terminals formed by bending an anode lead frame and a cathode lead frame along a resin package and which makes it easy to check formation of a solder fillet during mounting the solid electrolytic capacitor.

The present invention is directed to a solid electrolytic capacitor including: a capacitor element part having an anode portion and a cathode portion; an anode lead frame connected to the anode portion; a cathode lead frame connected to the cathode portion; and a resin package enclosing the capacitor element part other than areas from which the anode lead frame and the cathode lead frame are drawn out, wherein the anode lead frame and the cathode lead frame are bent to be located along a side surface and a bottom surface of the resin package, and at least one of the anode lead frame and the cathode lead frame has a projecting portion extending outward from a portion located along the bottom surface of the resin package.

The projecting portion preferably extends in a direction substantially parallel to the bottom surface of the solid electrolytic capacitor. Further, the projecting portion preferably has a cutout portion penetrating in a thickness direction thereof

The anode lead frame may have an anode connecting portion to be connected to the anode portion, an anode side surface portion to be located along the side surface of the resin package, and an anode terminal portion to be located along the bottom surface of the resin package, and the cathode lead frame may have a cathode connecting portion to be connected to the cathode portion, a cathode side surface portion to be located along the side surface of the resin package, and a cathode terminal portion to be located along the bottom surface of the resin package. In this case, the anode side surface portion and/or the cathode side surface portion have/has a rising portion which is formed in such a manner that at least one of both ends of a boundary between the anode side surface portion and the anode terminal portion remains and which is raised by bending the anode lead frame at the boundary as a supporting point and/or a rising portion which is formed in such a manner that at least one of both ends of a boundary between the cathode side surface portion and the cathode terminal portion remains and which is raised by bending the cathode lead frame at the boundary as a supporting point, and the rising portion provides the projecting portion.

Alternatively, the anode side surface portion and/or the cathode side surface portion may have a rising portion which is formed in such a manner that both ends of a boundary between the anode side surface portion and the anode terminal portion remain and which is raised by bending the anode lead frame at the boundary as a supporting point and/or a rising portion which is formed in such a manner that both ends of a boundary between the cathode side surface portion and the cathode terminal portion remain and which is raised by bending the cathode lead frame at the boundary as a supporting point.

The rising portion can be formed by making an incision in the anode side surface portion and/or the cathode side surface portion.

At least one of the anode side surface portion and the cathode side surface portion preferably has a cutout portion formed to extend from the incision toward the rising portion.

The capacitor element part may be formed of one capacitor element or a plurality of capacitor elements stuck on top of one another.

As described above, in the solid electrolytic capacitor having such a structure described above, at least one of the anode lead frame and the cathode lead frame has a projecting portion extending outward from its portion (i.e., from its terminal portion) located along the bottom surface of the resin package. Therefore, it is possible to easily check formation of a solder fillet during mounting the solid electrolytic capacitor. More specifically, since the projecting portion is formed to project from the terminal portion, it is possible to easily check formation of a solder fillet by checking formation of a solder fillet at the projecting portion. Further, since the projecting portion to be used for checking formation of a solder fillet is formed at the same time as bending at least one of the anode lead frame and the cathode lead frame along the resin package, it is not necessary to provide an additional step of forming a part for use in checking formation of a solder fillet after bending the anode lead frame and/or the cathode lead frame. This makes it possible to efficiently produce a solid electrolytic capacitor.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1A is a plan view of a preferred embodiment of a solid electrolytic capacitor according to the present invention.

FIG. 1B is a sectional view taken along the A-A′ line in FIG. 1A.

FIG. 1C is a side view of the solid electrolytic capacitor shown in FIG. 1A.

FIG. 2 is a sectional view of a preferred example of a capacitor element to be used for a solid electrolytic capacitor according to the present invention.

FIG. 3(a) is a plan view of a preferred example of an anode lead frame to be used for a solid electrolytic capacitor according to the present invention.

FIG. 3(b) is a plan view of a preferred example of a cathode lead frame to be used for a solid electrolytic capacitor according to the present invention.

FIG. 4(a) is a plan view of another preferred example of an anode lead frame to be used for a solid electrolytic capacitor according to the present invention.

FIG. 4(b) is a plan view of another preferred example of a cathode lead frame to be used for a solid electrolytic capacitor according to the present invention.

FIG. 5(a) is a plan view of another preferred example of an anode lead frame to be used for a solid electrolytic capacitor according to the present invention.

FIG. 5(b) is a plan view of another preferred example of a cathode lead frame to be used for a solid electrolytic capacitor according to the present invention.

FIG. 6A is a plan view of a conventional solid electrolytic capacitor.

FIG. 6B is a sectional view taken along the X-X′ line in FIG. 6A.

FIG. 6C is a side view of the conventional solid electrolytic capacitor shown in FIG. 6A.

### DESCRIPTION OF THE PREFERRED EMBODIMENTS

### First Embodiment

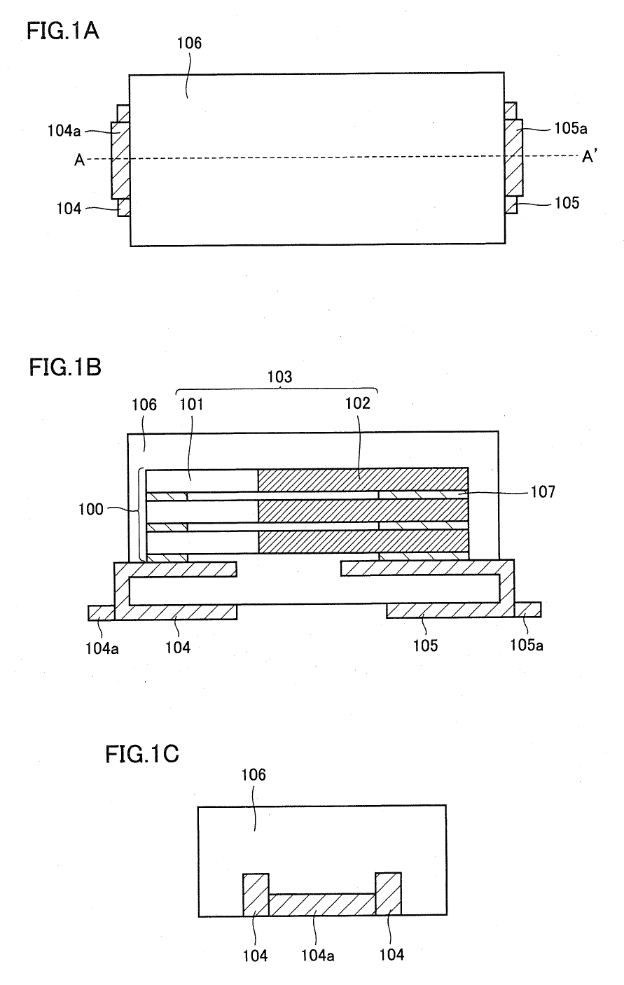

FIG. 1A is a schematic plan view of a preferred embodiment of a solid electrolytic capacitor according to the present invention, FIG. 1B is a schematic sectional view taken along the A-A′ line in FIG. 1A, and FIG. 1C is a schematic side view of the solid electrolytic capacitor shown in FIG. 1A. The solid electrolytic capacitor shown in FIGS. 1A to 1C mainly includes: a capacitor element part 100 obtained by stacking three capacitor elements 103 each having an anode portion 101 and a cathode portion 102; an anode lead frame 104 connected to the anode portion of the capacitor element located at the bottom of capacitor element part 100; and a cathode lead frame 105 connected to the cathode portion of the capacitor element located at the bottom of capacitor element part 100; and a resin package 106 enclosing capacitor element part 100 other than areas from which anode lead frame 104 and cathode lead frame 105 are drawn out. Anode portions 101 of capacitor elements 103 are connected to one another by, for example, resistance welding. On the other hand, cathode portions 102 of capacitor elements 103 are connected to one another by, for example, a conductive paste 107.

Anode and cathode lead frames 104 and 105 protruded out of resin package 106 are bent so as to be located along the side surface and the bottom surface of resin package 106. In each of anode and cathode lead frames 104 and 105, a portion located along the bottom surface of resin package 106 (i.e., a terminal portion) serves as a contact surface with a mounting substrate.

It is to be noted that anode and cathode lead frames 104 and 105 of the solid electrolytic capacitor according to the first embodiment of the present invention have projecting portions 104a and 105a, respectively, each of which extends toward the outside of the solid electrolytic capacitor from its portion located along the bottom surface of resin package 106.

By providing such projecting portions, it is possible to easily check formation of solder fillets during mounting the solid electrolytic capacitor onto a mounting substrate by, for example, looking at the solid electrolytic capacitor from above, thereby making it possible to reliably connect the solid electrolytic capacitor to the mounting substrate.

Each of the projecting portions preferably extends in a direction substantially parallel to the bottom surface of the solid electrolytic capacitor so that the entire bottom surface thereof comes into contact with the mounting substrate.

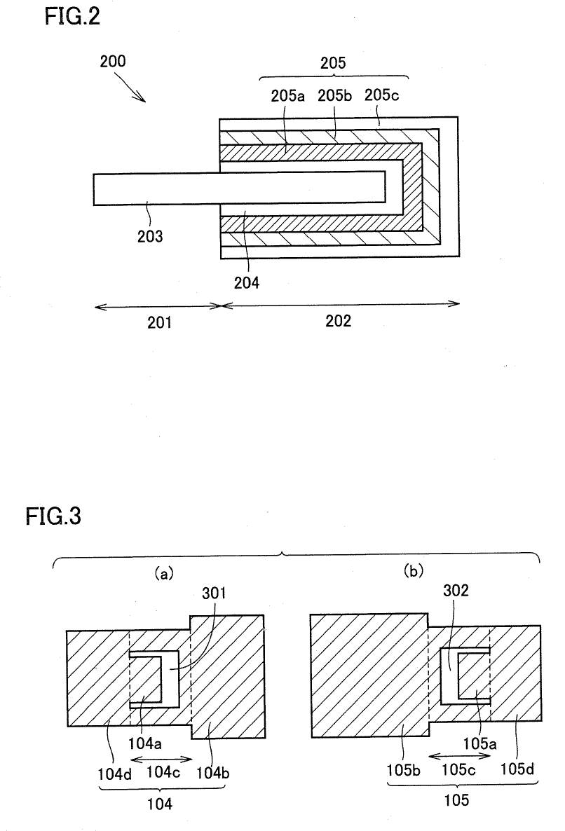

FIG. 2 is a sectional view of a preferred example of a capacitor element to be used for a solid electrolytic capacitor according to the present invention. A capacitor element 200 shown in FIG. 2 is preferably used as a capacitor element of the solid electrolytic capacitor according to the first embodiment of the present invention. Capacitor element 200 shown in FIG. 2 has an anode portion 201 and a cathode portion 202. More specifically, capacitor element 200 is produced by coating the surface of a part (i.e., a part serving as cathode portion 202) of a valve action metal foil 203, such as aluminum, with a dielectric film 204 and then with a cathode layer 205 formed of a solid electrolyte 205a, a carbon layer 205b, and a silver paste layer 205c.

Examples of solid electrolyte 205a include conductive polymers such as polypyrrole, polythiophene, and polyflan, and a TCNQ (7,7,8,8-tetracyanoquinodimethane) complex salt.

It is to be noted that in the present invention, instead of such a capacitor element using a valve action metal foil as an anode, a capacitor element using a sintered body as an anode can also be used.

The solid electrolytic capacitor according to the first embodiment of the present invention can be produced by, for example, the following method. First, anode lead frame 104 is connected to anode portion 101 of capacitor element 103 by, for example, resistance welding, and cathode lead frame 105 is connected to cathode portion 102 using, for example, conductive paste 107.

It is to be noted that the solid electrolytic capacitor according to the first embodiment of the present invention uses anode and cathode lead frames shown in FIGS. 3(a) and 3(b) as anode and cathode lead frames 104 and 105, respectively.

Anode lead frame 104 shown in FIG. 3(a) has an anode connecting portion 104b to be connected to anode portion 101 of capacitor element 103, an anode side surface portion 104c to be located along the side surface of resin package 106, and an anode terminal portion 104d to be located along the bottom surface of resin package 106. Anode terminal portion 104d is a portion to be brought into contact with a mounting substrate.

Anode side surface portion 104c has a rising portion formed in such a manner that both ends of a boundary between anode side surface portion 104c and anode terminal portion 104d remain, and the rising portion is raised by bending anode lead frame 104 at the boundary as a supporting point. The rising portion is provided to serve as projecting portion 104a in the solid electrolytic capacitor shown in FIGS. 1A to 1C. The rising portion (projecting portion 104a) can be formed by making an incision in anode side surface portion 104c and then forming a cutout portion 301 extending from the incision toward the rising portion. By providing cutout portion 301, it is possible to allow the rising portion to be easily raised from anode side surface portion 104c when anode lead frame 104 is bent at a boundary between anode side surface portion 104c and anode terminal portion 104d as a supporting point.

Like anode lead frame 104, cathode lead frame 105 shown in FIG. 3(b) has a cathode connecting portion 105b to be connected to cathode portion 102 of capacitor element 103, a cathode side surface portion 105c to be located along the side surface of resin package 106, and a cathode terminal portion 105d to be located along the bottom surface of resin package 106. Cathode terminal portion 105d is a portion to be brought into contact with a mounting substrate.

Cathode side surface portion 105c has a rising portion formed in such a manner that both ends of a boundary between cathode side surface portion 105c and cathode terminal portion 105d remain, and the rising portion is raised by bending cathode lead frame 105 at the boundary as a supporting point. The rising portion is provided to serve as projecting portion 105a in the solid electrolytic capacitor shown in FIGS. 1A to 1C. The rising portion (projecting portion 105a) can be formed by making an incision in cathode side surface portion 105c and then forming a cutout portion 302 extending from the incision toward the rising portion. By providing cutout portion 302, it is possible to allow the rising portion to be easily raised from cathode side surface portion 105c when cathode lead frame 105 is bent at a boundary between cathode side surface portion 105c and cathode terminal portion 105d as a supporting point.

Alternatively, anode lead frame 104 may have a rising portion which is formed in such a manner that one end of a boundary between anode side surface portion 104c and anode terminal portion 104d remains and which is raised by bending anode lead frame 104 at the boundary as a supporting point, and cathode lead frame 105 may have a rising portion which is formed in such a manner that one end of a boundary between cathode side surface portion 105c and cathode terminal portion 105d remains and which is raised by bending cathode lead frame 105 at the boundary as a supporting point.

Further, the shape of each of the rising portions of anode and cathode lead frames 104 and 105 is not particularly limited. For example, each of the rising portions may be defined by a straight line as shown in FIGS. 3(a) and 3(b) or may be defined by a curved line.

Anode connecting portion 104b of anode lead frame 104 having the structure described above and cathode connecting portion 105b of cathode lead frame 105 having the structure described above are connected to anode portion 101 and cathode portion 102 of capacitor element 103, respectively. Then, on capacitor element 103, another one or more capacitor elements 103 are stuck to construct capacitor element part 100 (in FIG. 1B, another two capacitor elements are stuck). The anode portions of capacitor elements 103 are connected to one another by, for example, resistance welding, and cathode portions 102 of capacitor elements 103 are connected to one another using, for example, conductive paste 107. It is to be noted that capacitor element part 100 may be formed of one capacitor element.

Then, capacitor element part 100 is covered with resin package 106, and then anode and cathode lead frames 104 and 105 protruded out of resin package 106 are bent so as to be located along the side surface and the bottom surface of resin package 106. In this way, the solid electrolytic capacitor shown in FIGS. 1A to 1C is produced. It is to be noted that the rising portions of anode and cathode lead frames 104 and 105 are raised from anode and cathode side surface portions 104c and 105c, respectively, at the same time as bending anode and cathode lead frames 104 and 105 so that terminal portions 104d and 105d are located along the bottom surface of resin package 106, and as a result, projecting portions 104a and 105a are formed (see FIG. 1B). By providing projecting portions 104a and 105a, it is possible to easily check formation of solder fillets during mounting the solid electrolytic capacitor.

### Second Embodiment

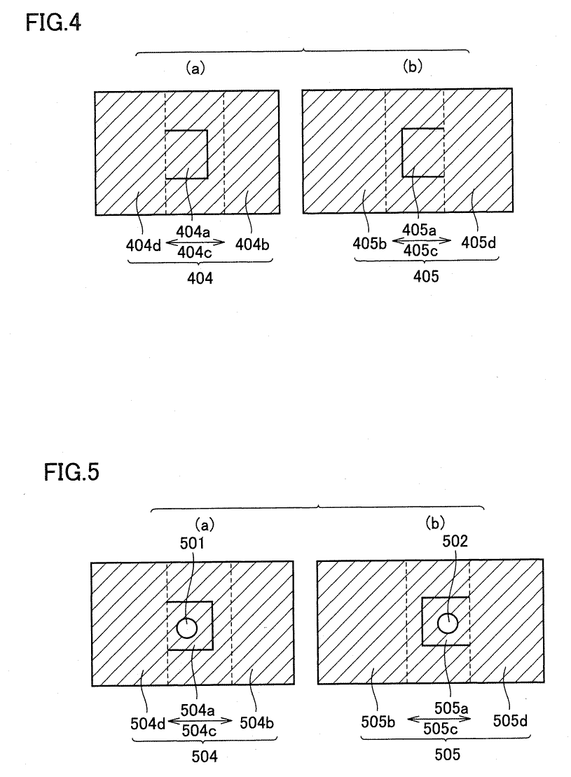

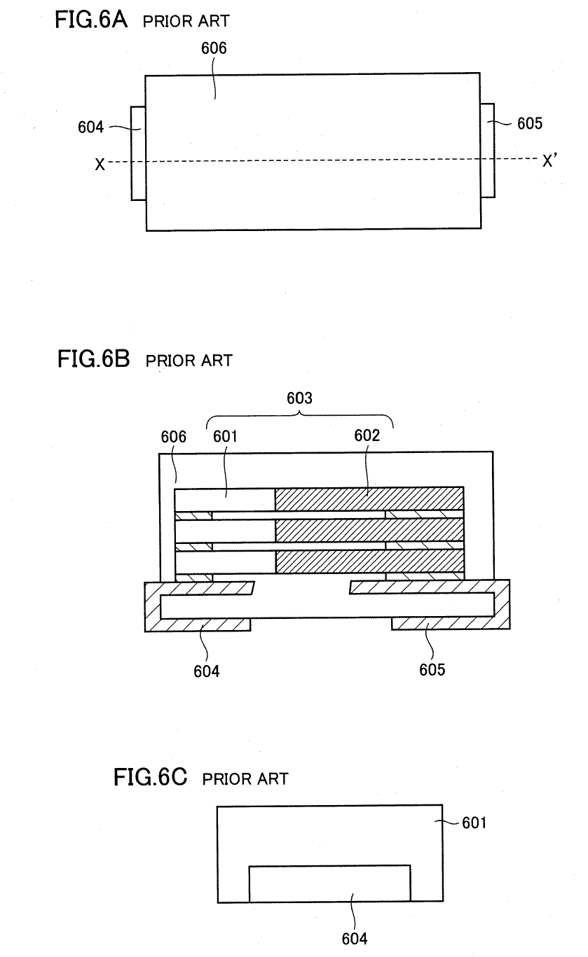

A solid electrolytic capacitor according to a second embodiment of the present invention is the same as the solid electrolytic capacitor according to the first embodiment except that anode and cathode lead frames 104 and 105 shown in FIG. 3 are replaced with anode and cathode lead frames 404 and 405 shown in FIG. 4.

Anode lead frame 404 shown in FIG. 4(a) has an anode connecting portion 404b to be connected to the anode portion of the capacitor element, an anode side surface portion 404c to be located along the side surface of the resin package, and an anode terminal portion 404d to be located along the bottom surface of the resin package. Anode terminal portion 404d is a portion to be brought into contact with a mounting substrate.

Anode side surface portion 404c has a rising portion 404a formed in such a manner that both ends of a boundary between anode side surface portion 404c and anode terminal portion 404d remain, and rising portion 404a is raised by bending anode lead frame 404 at the boundary as a supporting point. Rising portion 404a is provided to serve as the projecting portion in the solid electrolytic capacitor. Rising portion 404a can be formed by making an incision in anode side surface portion 404c.

Like anode lead frame 404, cathode lead frame 405 shown in FIG. 4(b) has a cathode connecting portion 405b to be connected to the cathode portion of the capacitor element, a cathode side surface portion 405c to be located along the side surface of the resin package, and a cathode terminal portion 405d to be located along the bottom surface of the resin package. Cathode terminal portion 405d is a portion to be brought into contact with a mounting substrate.

Cathode side surface portion 405c has a rising portion 405a formed in such a manner that both ends of a boundary between cathode side surface portion 405c and cathode terminal portion 405d remain, and rising portion 405a is raised by bending cathode lead frame 405 at the boundary as a supporting point. Rising portion 405a is provided to serve as the projecting portion in the solid electrolytic capacitor. Rising portion 405a can be formed by making an incision in cathode side surface portion 405c.

### Third Embodiment

A solid electrolytic capacitor according to a third embodiment of the present invention is the same as the solid electrolytic capacitor according to the first embodiment except that anode and cathode lead frames 104 and 105 shown in FIG. 3 are replaced with anode and cathode lead frames 504 and 505 shown in FIG. 5.

Anode lead frame 504 shown in FIG. 5(a) has an anode connecting portion 504b to be connected to the anode portion of the capacitor element, an anode side surface portion 504c to be located along the side surface of the resin package, and an anode terminal portion 504d to be located along the bottom surface of the resin package. Anode terminal portion 504d is a portion to be brought into contact with a mounting substrate.

Anode side surface portion 504c has a rising portion 504a formed in such a manner that both ends of a boundary between anode side surface portion 504c and anode terminal portion 504d remain, and rising portion 504a is raised by bending anode lead frame 504 at the boundary as a supporting point. Rising portion 504a is provided to serve as the projecting portion in the solid electrolytic capacitor. Rising portion 504a can be formed by making an incision in anode side surface portion 504c.

Like anode lead frame 504, cathode lead frame 505 shown in FIG. 5(b) has a cathode connecting portion 505b to be connected to the cathode portion of the capacitor element, a cathode side surface portion 505c to be located along the side surface of the resin package, and a cathode terminal portion 505d to be located along the bottom surface of the resin package. Cathode terminal portion 505d is a portion to be brought into contact with a mounting substrate.

Cathode side surface portion 505c has a rising portion 505a formed in such a manner that both ends of a boundary between cathode side surface portion 505c and cathode terminal portion 505d remain, and rising portion 505a is raised by bending cathode lead frame at the boundary as a supporting point. Rising portion 505a is provided to serve as the projecting portion in the solid electrolytic capacitor. Rising portion 505a can be formed by making an incision in cathode side surface portion 505c.

Rising portions 504a and 505a have cutout portions 501 and 502 penetrating in their thickness direction, respectively. By providing such a cutout portion, it is easy to visually check formation of a solder fillet during mounting the solid electrolytic capacitor onto a mounting substrate because solder is squeezed out of the cutout portion. In addition, it is also possible to enhance adhesion between the solid electrolytic capacitor and the mounting substrate.

It is to be noted that in each of the solid electrolytic capacitors according to the first to third embodiments of the present invention, the projecting portion is provided in each of the anode and cathode lead frames, but may be provided in only one of the anode and cathode lead frames.

Although the present invention has been described and illustrated in detail, it is clearly understood that the same is by way of illustration and example only and is not to be taken by way of limitation, the scope of the present invention being interpreted by the terms of the appended claims.

What is claimed is:

1. A solid electrolytic capacitor comprising:
a capacitor element part having an anode portion and a cathode portion;
an anode lead frame connected to said anode portion;
a cathode lead frame connected to said cathode portion; and
a resin package enclosing said capacitor element part other than areas from which said anode lead frame and said cathode lead frame are drawn out, wherein
said anode lead frame and said cathode lead frame are bent to be located along a side surface and a bottom surface of said resin package, and
at least one of said anode lead frame and said cathode lead frame has a projecting portion extending outward from a portion located along the bottom surface of said resin package.

2. The solid electrolytic capacitor according to claim 1, wherein said projecting portion extends in a direction substantially parallel to the bottom surface of the solid electrolytic capacitor.

3. The solid electrolytic capacitor according to claim 1, wherein said projecting portion has a cutout portion penetrating in a thickness direction thereof

4. The solid electrolytic capacitor according to claim 1, wherein
said anode lead frame has an anode connecting portion to be connected to said anode portion, an anode side surface portion to be located along the side surface of said resin package, and an anode terminal portion to be located along the bottom surface of said resin package,
said cathode lead frame has a cathode connecting portion to be connected to said cathode portion, a cathode side surface portion to be located along the side surface of said resin package, and a cathode terminal portion to be located along the bottom surface of said resin package,
said anode side surface portion and/or said cathode side surface portion have/has a rising portion which is formed in such a manner that at least one of both ends of a boundary between said anode side surface portion and said anode terminal portion remains and which is raised by bending said anode lead frame at said boundary as a supporting point and/or a rising portion which is formed in such a manner that at least one of both ends of a boundary between said cathode side surface portion and said cathode terminal portion remains and which is raised by bending said cathode lead frame at said boundary as a supporting point, and
said rising portion provides said projecting portion.

5. The solid electrolytic capacitor according to claim 4, wherein said anode side surface portion and/or said cathode side surface portion have/has a rising portion which is formed in such a manner that both ends of a boundary between said anode side surface portion and said anode terminal portion remain and which is raised by bending said anode lead frame at said boundary as a supporting point and/or a rising portion which is formed in such a manner that both ends of a boundary between said cathode side surface portion and said cathode terminal portion remain and which is raised by bending said cathode lead frame at said boundary as a supporting point.

6. The solid electrolytic capacitor according to claim 4, wherein said rising portion is formed by making an incision in said anode side surface portion and/or said cathode side surface portion.

7. The solid electrolytic capacitor according to claim 6, wherein at least one of said anode side surface portion and said cathode side surface portion has a cutout portion formed to extend from said incision toward said rising portion.

8. The solid electrolytic capacitor according to claim 1, wherein said capacitor element part is formed of one capacitor element.

9. The solid electrolytic capacitor according to claim 1, wherein said capacitor element part is formed of a plurality of capacitor elements stuck on top of each another.
